(19) United States
(12) Patent Application Publication
(10) Pub. No.: US 2010/0098844 A1
(43) Pub. Date: Apr. 22, 2010

(54) Application of ultraviolet reflective materials to surfaces to enhance avian and human safety

(76) Inventor: Frank Emest Pettinger, Moraga, CA (US)

Correspondence Address: Frank Pettinger, 106 Greenbriar, Moraga, CA, 94556, US

(21) Appl. No.: 12/383,987

(22) Filed: Mar. 30, 2009

Related U.S. Application Data
(60) Provisional application No. 61/072,656, filed on Apr. 2, 2008.

(51) Int. Cl. B05D 5/06

(52) U.S. Cl. 427/164; 427/162

(57) ABSTRACT

The purpose of this invention, what is being patented, is the application of ultraviolet lights or reflective paint, coating or other material to serve as a means of creating a reflective surface for ultraviolet light. The advantages are many including use on any object that is subject to bird impact—solid or transparent—moving or non-moving, This invention is also valuable when applied to interior surfaces of sanitation equipment (like air conditioning ducts, ultraviolet air cleaners, ultraviolet water purifiers) which are then struck by ultraviolet light to reflect (or bounce) the light and enhance the area of coverage and effectiveness.

### CROSS REFERENCE AND RELATED APPLICATION

This application claims priority to U.S. Provisional Patent Application number 61/072,656 filed Apr. 2, 2008 entitled “Bird safe blades and other structures.”

### BACKGROUND OF THE INVENTION

It is common knowledge that birds have a problem recognizing the moving blades of wind turbines and airplane engines, as well as stationary structures like communication towers and transparent materials like windows. Birds are struck and injured or killed by the moving blades or injured from the impact of flying into the structures.

When birds encounter these types of objects they too frequently have a difficult time recognizing them and impact can occur. Normal and traditional means of resolving this have only been somewhat effective.

There are many government & municipal agencies, developers, architects, planners, construction and renovation companies wishing to achieve bird-friendly certification for their buildings.

The fact is, in order to prevent birds from colliding with windows, one must make glass appear as a solid object to the bird's eye. Existing techniques that follow a tried-and-true bird-friendly criterion fail to satisfy commercial tastes. Though the demands of the corporate sector in maintaining aesthetically attractive building facades must be recognized and respected, an agreeable solution must be found to stop the death toll of birds from steadily increasing.

Bird collisions with windows are now ranked one of the leading causes of bird death across North America. Therefore, the urgency to find a viable solution has reached an all-time high. A viable, bird-friendly glass that serves to protect millions of migratory birds in the urban environment is a crucial and commercial necessity.

To meet the demands of the corporate sector means finding a technique that is discernible only to the bird's eye. This can be done by obtaining a better understanding of the fascinating world of birds, how they perceive and respond to the environment. This invention is intended to address this.

Every year, approximately 7,000 to 8,000 avian strikes are reported to the Federal Aviation Administration primarily by commercial airlines nationwide. The reporting is a voluntary system. It's not mandatory, so not all of the avian strikes are being reported. It is estimated that as much as 80 percent of the strikes are not reported. http://www.cnn.com/2009/TECH/01/15/dolbeer.birdstrikes/

In addition to avian populations increasing, they've also adapted to urban environments. They're not afraid to associate with people. Traffic and aircraft don't bother them. So they're more likely to be seen near airports.

Another important factor is modern turbofan aircraft like the Airbus 320. Their engines are much quieter than older aircraft. And almost all the noise comes out of the back of the engine. Birds are less able to hear or see modern aircraft. There are more airplanes in the sky, more birds in the sky and this is where the conflict comes in.

The number of strikes being reported is definitely increasing. In 1990, the FAA had approximately 1,750 strikes reported and in 2007 there were 7,600.

The three basic things that airports can do and many airports are doing are habitat management at the airport to make it as sterile as possible for birds; dispersal of birds by a trained bird control crew that goes out and uses pyrotechnics and other means to scare the birds away; and removal of birds when the habitat management and dispersal do not work by using a shotgun to demonstrate to the other birds that this is not a place to be. The last is a very selective lethal control.

A viable bird friendly warning system needs to be developed and this invention is intended to address this.

Then there is the application to wind turbine blades; although wind energy is generally considered environmentally friendly (because it generates electricity without emitting air pollutants or greenhouse gases), the potential for avian fatalities from blade impact has delayed and even significantly contributed to blocking the development of some wind plants in the U.S. Given the importance of developing a viable renewable source of energy, it is crucial to find a means to make wind turbines safer.

The idea of ultraviolet reflective material for bird safety is here presented as a novel method and treatment for avian safety.

The impact on avian safety is expected to be a lowering of the estimated more than 100 million avian fatalities annually in the United States due to collisions with human-made structures. http://www.nationalwind.org/publications/wildlife/avian_collisions.pdf

This invention is intended to lower the United States' annual avian collision mortality. It is currently estimated to be: 60 million-80 million from vehicles; 98 million-980 million from building and windows; tens of thousands-174 million from power lines; 4 million-50 million from communication towers; 10,000-40,000 wind generation facilities.

Airplanes—many turbine engines use a symbol painted on the center hub that under operational engine speeds looks to birds like the eye of a predator bird. Yet each year birds still fly into jet engines. In normal everyday situation birds do not recognize airplanes and their threat as moving objects. The application of a UV reflective or UV lights to the front facing surfaces of an airplane will bring the presence and movement into the bird's awareness more effectively.

Windows—bird collisions with windows is a common, unpleasant event. The transparent nature of windows does not represent a real or tangible object to birds. And there are certain buildings or structures where birds have easy access to the inside of the building or structure through large entries and then can not get out. The application is a UV reflective to the windows (inside and out) will bring the presence of the window into the bird's awareness more effectively and they will be better able to determine safe flight paths.

Power Lines, Communication Towers and Guide Wires—Birds are not prone to fly into mountains, trees or other natural structures, but they have a more difficult time recognizing man made structures and this lack of recognition can be fatal. The application is a UV reflective to the structures will bring the presence into the bird's awareness more effectively and they will be able to determine effective flight paths.

Wind Turbines—When wind turbine blades are moving they are not recognized as moving object by birds. Wind turbine blades kill 1000's of birds annually. Wind turbines and wind farms are frequently placed in bird migration flight paths where the topography forms a natural wind tunnel/channel. There is a dramatic negative environmental impact made by wind farms for this reason. There is not any real solution to this problem yet. Wind farms have been, are being and will be developed all over the world.

In light of the seriousness of the problem there have been proposed solutions that would require either reducing the hours of operation for wind farms in bird migratory paths or building future wind farms differently by placing wind turbine to account for the migratory flight paths. These proposed solutions would be a disadvantage for the wind farms, because they would miss the ideal wind patterns created by the natural topography.

The above proposed solutions will not be as effective as this invention which involves applying ultraviolet reflective materials to the objects which endanger birds. The previous art attempts to absorb ultraviolet not reflect it. The ultraviolet reflective treatment will be better for the environment, for man and bird because it can be applied to all existing as well as any future airplanes, windows, wind turbine blades and other objects and structures which endanger birds by increasing visibility no matter where they are situated.

### BRIEF SUMMARY OF THE INVENTION

This invention addresses the problem of birds flying into objects which are not seen or visible to the birds for a variety of reasons. The application of this invention will be to any object that is subject to bird impact—solid or transparent—moving or non-moving. This invention also applies to the application of ultraviolet reflective materials to surfaces which will enhance the application of reflecting ultraviolet light for sterilization or purification purposes.

The purpose of this invention, what is being patented, is the application of small ultraviolet (the particular spectrum of the bird's enhanced visual acuity) lights in the blades (without affecting the aerodynamic integrity) or to add ultraviolet reflective paint, coating or other material as a means of creating a visual warning to the birds about the presence and position of the dangerous objects and structures.

This invention is unique because no other wind turbine blades, airplane engines, windows, structures or surfaces have been designed in this fashion or for this purpose.

When the coating is applied and the surfaces treated with ultraviolet are struck by light containing ultraviolet they will emit an extraordinary visible reflection that will alert the birds to their presence. In this invention it is proposed that the paint or coating will be naturally activated by sunlight which contains ultraviolet light and on structures which need increased avian visibility at night, ultraviolet lights will be activated.

This invention can be applied to many objects and mechanizations of civilization and it can help prevent bird death and injuries. Additionally it will save millions of dollars of airplane and window damage. Furthermore it can help increase production, with fewer occurrences of bird fatalities or injuries, at wind farms. Productivity will not suffer (from cut back of on/off time) and the environmental image of wind farms will improve. New wind farms can be built to take advantage of the maximum wind flow, whether it is near the flight migration paths or not.

Until now there has been no effective way to warn birds that there are moving blades or “invisible” structures in their flight path. A deeper insight into bird perception revealed the answer might lie in the avian eye. Unlike humans, birds can see ultraviolet light (UV), light that is a part of natural sunlight. Birds use the message given by UV light for behaviors such as reproduction, feeding and navigation—avian life without UV light would be the equivalent of humans seeing everything in black and white, only worse. Without UV light, the avian ability to survive would be seriously compromised. http://beheco.oxfordjournals.org/cgi/content/abstract/19/2/369

### BRIEF DESCRIPTION OF THE SEVERAL DRAWINGS

FIG. 1 is an illustration depicting the application of the ultraviolet coating or ultraviolet lights to the wind turbine or propeller blades to make them more visible to birds.

FIG. 2 is an illustration depicting the application of the ultraviolet coating or ultraviolet lights to front surfaces of man-made moving objects to make them more visible to birds.

FIG. 3 is an illustration depicting the application of the ultraviolet coating to the interior surfaces of HVAC ducts or other sterilizing equipment in order to bounce the ultraviolet light and to make it more effective.

### DETAILED DESCRIPTION OF THE INVENTION

This invention applies to reflective uses of the ultraviolet light with respect to the full range of the ultraviolet spectrum found in sunlight and that which is emitted by electric arcs and specialized lights such as black and sterilizing lights. By ultraviolet we are referring to the spectrum as defined in the chart below.

The electromagnetic spectrum of ultraviolet light can be subdivided in a number of ways. The draft ISO standard on determining solar irradiances (ISO-DIS-21348) describes the following ranges:

| | | Wavelength range in | Energy per |
|---|---|---|---|
| Name | Abbreviation | nanometers | photon |
| Ultraviolet A, long | UVA | 400 nm-320 nm | 3.10-3.94 eV |
| wave, or black light | | | |
| Near | NUV | 400 nm-300 nm | 3.10-4.13 eV |
| Ultraviolet B or | UVB | 320 nm-280 nm | 3.94-4.43 eV |
| medium wave | | | |
| Middle | MUV | 300 nm-200 nm | 4.13-6.20 eV |
| Ultraviolet C, short | UVC | 280 nm-100 nm | 4.43-12.4 eV |
| wave, or germicidal | | | |
| Far | FUV | 200 nm-122 nm | 6.20-10.2 eV |
| Vacuum | VUV | 200 nm-10 nm | 6.20-124 eV |
| Extreme | EUV | 121 nm-10 nm | 10.2-124 eV |

The Sun emits ultraviolet radiation in the UVA, UVB, and UVC bands, but because of absorption in the atmosphere's ozone layer, 98.7% of the ultraviolet radiation that reaches the Earth's surface is UVA. (Some of the UVB and UVC radiation is responsible for the generation of the ozone layer.)

As an ionizing radiation it can cause chemical reactions, and causes many substances to glow or fluoresce. Most people are aware of the effects of UV through the painful condition of sunburn, but the UV spectrum has many other effects, both beneficial and damaging, on human health.

This invention is useful when applied to surfaces (like air conditioning ducts, ultraviolet air cleaners, ultraviolet water purifiers) which are then struck by ultraviolet light to reflect (or bounce) the light and enhance the area of coverage and effectiveness. The effectiveness of UV disinfection systems, commercial and residential UV air cleaners, which literally sterilize microorganisms, will be enhanced. Because ultraviolet light reduces or eliminates germs such as mold, viruses, bacteria, fungi and mold spores from the indoor air of homes, offices and commercial buildings, the reflective coating will amplify the effect, ensuring a higher indoor air quality. See FIG. 3.

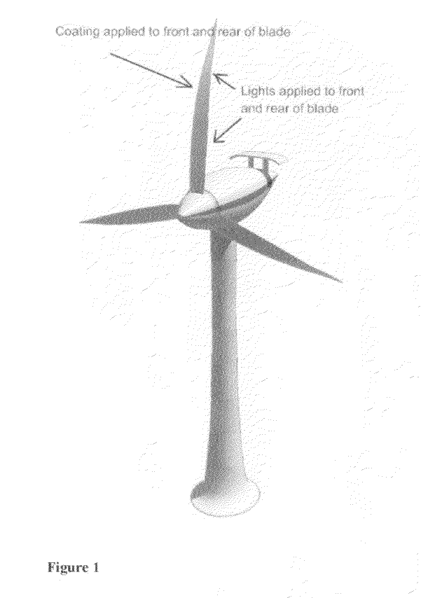

This ultraviolet reflective coating can also be retro-applied to all existing wind turbine blades, airplane engines (propeller and turbines), structures and surfaces to make them safer for birds and humans. See FIG. 1.

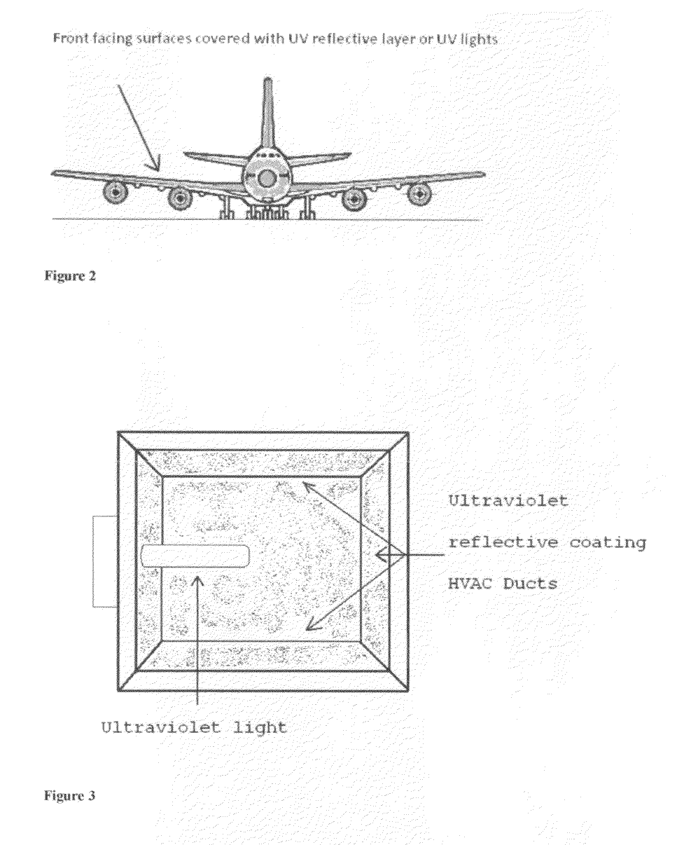

Since birds can see in the UV-range; with the proposed invention the visibility of aircraft to birds can be enhanced by using UV reflective coating or lights (flashing or continuous) and the frequency of collision will be reduced. See FIG. 2.

It should be noted that color (ultraviolet) is not actually a property of light or of objects that reflect light. It is a sensation that ‘arises within the brain’. For this to work birds need to be (and are) highly responsive to ultraviolet light waves. Greater that 90% of birds have UV specific eye sight and are sensitive to the UV (A&B) spectrum. This spectrum of light is vital to bird's survival and mating. http://www.newscientist.com/article/dn13584-uv-vision-reveals-chicks-healthy-glow-.html

### REFERENCES

### Patent No.

US2007/0190343
US20090047487A1
US20070044731A1
   Search (((ultra adj violet or ultraviolet) same (coat* or treat* or paint* or powder* or chalk or cover*) same (bird or avian) and (blade? or turbine? or window?))) and pd>=2000-01-01

1. A unique and novel application of an ultraviolet reflective coating applied to surfaces (like air conditioning ducts and coils, ultraviolet air cleaners, ultraviolet water purifiers) which when struck by ultraviolet light reflects (or bounces) the light to enhance the area of coverage and effectiveness. The effectiveness of UV disinfection systems, commercial and residential UV air cleaners, which literally sterilize microorganisms, will be enhanced. Because ultraviolet light reduces or eliminates germs such as mold, viruses, bacteria, fungi and mold spores from the indoor air of homes, offices and commercial buildings, the reflective coating will amplify the effect and eliminate dead spots, ensuring a higher indoor air quality. Example drawing FIG. 3.

2. A utility patent for the application of a UV reflective material to solid or transparent—moving or non-moving objects—so that when the sunlight, full spectrum or UV specific light illuminate the object it will be reflected back to the avian eye.

3. The application of claim 2 of the coating that reflects ultraviolet light waves to make stationary man made objects more visible to birds. These include but are not limited to windows, communication towers, power lines and buildings. The application of the proposed invention to these surfaces will render them highly visible to birds.

4. The application of claim 2 of the coating or lights which can be applied or built into moving blades of all types. These include but are not limited to propeller, jet turbines and wind turbine blades. The application of the proposed invention to these surfaces will render them highly visible to birds. Example drawing FIG. 1.

5. The application of claim 2 of the coating or lights (flashing or continuous) which reflect or illuminate ultraviolet light waves are applied to the front facing surfaces of man made moving objects to make them more visible to birds. Example drawing FIG. 2. These include but are not limited to moving vehicles: cars, trains, airplanes. The application of the proposed invention to these surfaces will render them highly visible to birds. Avian eyes register UV light and that creates a sensation in the brain. This sensation will do a better job of alerting and then keeping birds away from the objects which are reflecting the light.

6. The application of claim 2 of the coating (powder, chalk, dust) or lights which is specifically designed reflect or illuminate ultraviolet light waves when struck by light containing this wave length for the purposes of alerting birds to the present of the object. The application of the proposed invention to these surfaces will render them highly visible to birds.
